(19) United States
(12) Patent Application Publication
(10) Pub. No.: US 2009/0232008 A1
(43) Pub. Date: Sep. 17, 2009

(54) SYSTEM FOR CONNECTING EQUIPMENT WITH A SERVICE PROVIDER, APPARATUS FOR FACILITATING DIAGNOSTIC AND/OR MANAGEMENT COMMUNICATION WITH SUCH EQUIPMENT, AND PROCEDURE FOR COMMUNICATING WITH SUCH EQUIPMENT

(75) Inventors: Michael J. Wurst, Santa Rosa, CA (US); Marc R. Bernard, Miramar, FL (US)

Correspondence Address: FITZPATRICK CELLA (TELLABS), 30 ROCKEFELLER PLAZA, NEW YORK, NY, 10112-3800, US

(73) Assignee: TELLABS PETALUMA, INC., Naperville, IL (US)

(21) Appl. No.: 12/046,602

(22) Filed: Mar. 12, 2008

(51) Int. Cl. H04L 12/26

(52) U.S. Cl. 370/245

(57) ABSTRACT

A system, apparatus, and procedure connects customer premises equipment with a service provider network and includes a first local area network, a second local area network, and a management interface device. The first local area network connects the customer premises equipment to the service provider network and is configured to transmit primary service signals to and receive primary service signals from the customer premises equipment. The second local area network connects the customer premises equipment to the service provider network via the management interface device and is configured to transmit diagnostic and/or management signals from the service provider network to the customer premises equipment through the management interface device and/or to receive diagnostic and/or management signals from the customer premises equipment and transmit those signals to the service provider network through the management interface device. These various functions can also be instructed to be performed by a software computer program or computer program product.

### BACKGROUND OF THE INVENTION

1. Field of the Invention

Example aspects of the invention relate to the field of network communications. More specifically, example aspects of the invention relate to the field of wired and wireless data, video, and audio communication between a service provider's network and customer premises equipment on a customer's premises via a network interface device.

2. Description of Related Art

Today it is common for homes and offices to contain many pieces of customer premises equipment (CPE) that provide, receive and/or support services, such as voice communication, video communication, data services, and instant messaging (IM) from a service provider (SP). Examples of these devices include wireless and wired telephones, alarm systems, computers, digital cameras, televisions, broadband home routers, and set top boxes. Typically, these pieces of customer premises equipment communicate with the network of the service provider over a local area network (LAN) via a wired or wireless connection. With the growing complexity of customer premises equipment, there is a growing need for the service provider to monitor, diagnose, configure, and maintain such equipment. The wide area network (WAN) of the service provider that can monitor, diagnose, configure, and maintain such equipment is reliable. But the customer premises equipment is not connected directly to the WAN. Rather, it is connected to the WAN through one or more LANs. And the LANs over which the customer premises equipment are connected to the WAN of the service provider can be unreliable. In addition, customers typically set up and maintain their LAN, and most customers do not have the expertise to ensure that their LAN is properly configured to carry out all of these service-provider functions. This unreliability not only makes it difficult for the service provider to maintain these devices, but also can cause the customer to lose service. Thus, it would be useful to have a reliable way for the service provider to monitor, diagnose, configure, and maintain customer premises equipment.

### SUMMARY OF THE INVENTION

Example embodiments described herein provide a system for connecting customer premises equipment with a service provider network comprising a first local area network connecting the customer premises equipment to the network of the service provider and configured to transmit primary service signals to and receive primary service signals from the customer premises equipment, and a second local area network connecting the customer premises equipment to the network of the service provider and configured to transmit diagnostic and/or management signals to the customer premises equipment and/or to receive diagnostic and/or management signals from the customer premises equipment.

Example embodiments described herein also provide an apparatus for facilitating diagnostic and/or management communication via a diagnostic and/or management channel to customer premises equipment that provides, receives, and/or supports services from a service provider via a primary service channel. The apparatus comprises a management interface device configured to connect to a network of the service provider and configured to transmit diagnostic and/or management signals to and receive diagnostic and/or management signals from the customer premises equipment via the diagnostic and/or management channel.

Example embodiments described herein also provide a procedure of communicating with customer premises comprising the performing of management and/or diagnostic communication between a management interface device and the customer premises equipment over a first local area network. The management interface device is configured to also communicate with a management system of a service provider to permit management and/or diagnostic communication between the management system of the service provider and the customer premises equipment. The procedure also comprises the performing of primary-services communication between the customer premises equipment and a services interface device over a second local area network to provide or support primary services from the service provider. The services interface device is configured to connect to a core network of the service provider.

Further features and advantages, as well as the structure and operation, of various example embodiments of the present invention are described in detail below with reference to the accompanying drawings.

### BRIEF DESCRIPTION OF THE DRAWINGS

The features and advantages of the example embodiments of the invention presented herein will become more apparent from the detailed description set forth below when taken in conjunction with the drawings in which like reference numbers indicate identical or functionally similar elements.

FIG. 1 is a schematic block diagram of an example embodiment of an arrangement in which two local area networks (LANs) connect CPE with a network of a service provider.

FIG. 2 is a schematic block diagram of an example embodiment of the equipment that connects the service provider network with the two LANs.

FIG. 3 is a schematic block diagram of one example embodiment of an optical network terminal (ONT) that includes a management interface device (MID) connected to two LANs on a customer's premises.

FIG. 4 is a schematic block diagram of an example embodiment of a system in which an ONT is separate from an MID, and in which the two LANs terminate at the MID.

FIG. 5 is a schematic block diagram of an example embodiment of a system in which an ONT is separate from an MID, and in which the two LANs terminate at the ONT.

FIG. 6 is a schematic block diagram of an example embodiment of a system in which an ONT is separate from an MID, and in which one LAN terminates at the MID and the other LAN terminate at the ONT.

FIG. 7 is a schematic block diagram of one example embodiment of a system in which a single access point connects an SP core network and an SP management system to the CPE on the premises of a customer.

FIG. 8 is a schematic block diagram of one example embodiment of a system in which the management system and the core network of the SP have separate access points to access the CPE on the premises of a customer.

FIG. 9A is a flow chart of one example embodiment of a procedure of transmitting signals from the SP to the CPE over wireless and wired LANs using an MID and an optical network terminal at the customer's premises, an optical network unit at the curb, or an optical network device at a central office (collectively abbreviated as ONx), respectively.

FIG. 9B is a flow chart of one example embodiment of a procedure of transmitting signals from CPE to an SP over wireless and wired LANs using an MID and an ONx, respectively.

FIG. 10A is a flow chart of one example embodiment of a procedure of transmitting signals from an SP to CPE over wired LANs using an MID and an ONx.

FIG. 10B is a flow chart of one example embodiment of a procedure of transmitting signals from CPE to an SP over wired LANs using an MID and an ONx.

FIG. 11A is a flow chart of one example embodiment of a procedure of transmitting signals from an SP to CPE over a bidirectional wired or wireless LAN using an ONx.

FIG. 11B is a flow chart of one example embodiment of a procedure of transmitting signals from CPE to an MID over a unidirectional wireless LAN and of transmitting signals from CPE to an ONx over a bidirectional wireless or wired LAN.

FIG. 12 is a flow chart of one example embodiment of a procedure of delivering or supporting diagnostic and/or management services to diagnose and/or manage CPE using an MID and its associated LAN and delivering or supporting primary services to deliver or support primary services delivered or supported by CPE using an ONx and its associated LAN

### DETAILED DESCRIPTION OF THE INVENTION

The example embodiments of the invention presented herein are directed to apparatuses, procedures, systems, and computer program products for allowing a service provider to monitor, diagnose, configure, and maintain customer premises equipment, which are now described herein in terms of example MIDs and example management/diagnostic LAN-Bs. This description is not intended to limit the application of the example embodiments presented herein. In fact, after reading the following description, it will be apparent to one skilled in the relevant art(s) how to implement the following example embodiments in alternative example embodiments.

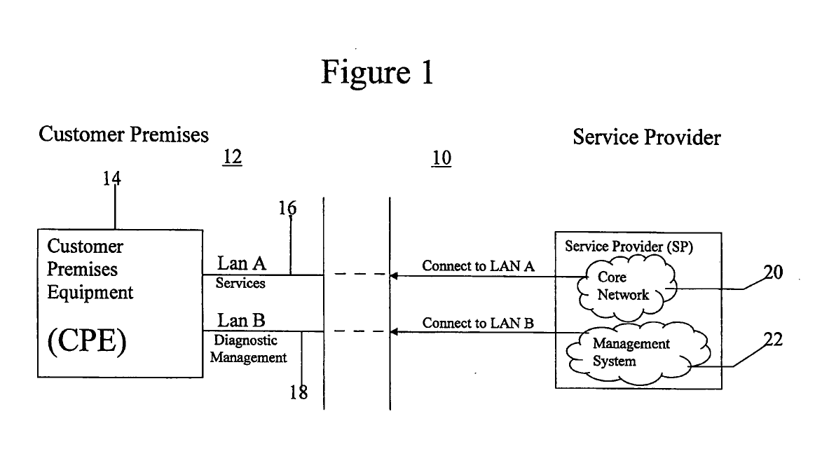

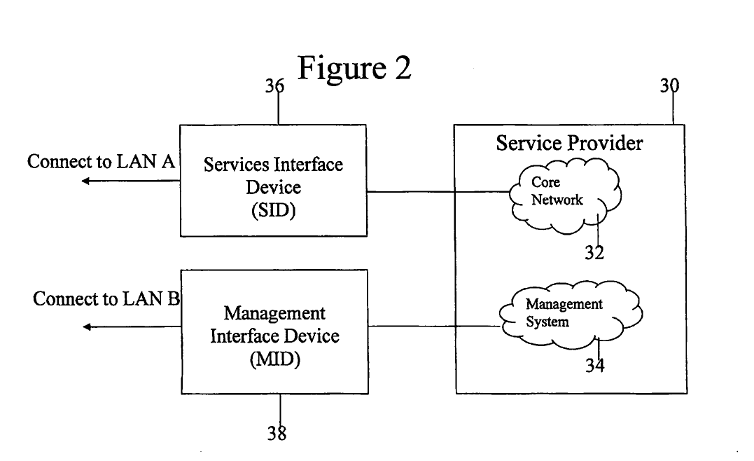

FIG. 1 illustrates one example embodiment of a service provider network 10 that supplies services to the customer at the customer's premises 12. Non-limiting examples of the customer premises 12 are a customer's home and a customer's place of business. The customer premises can include one or more pieces of customer premises equipment (CPE) 14 connected to a primary services LAN 16, also called LAN A, and a diagnostic/management LAN 18, also called LAN B. The primary services LAN 16 can transmit primary services signals from the CPE 14 to a service provider core network 20 and can transmit primary services signals from the core network 20 to the CPE 14. The diagnostic/management LAN 18 can transmit diagnostic/management signals from the CPE 14 to a service provider management system 22 of the service provider network 10 and can transmit diagnostic/management signals from the service provider management system 22 to the CPE 14. The primary services LAN 16 can connect to the service provider network 10 via one or more devices (not shown) including but not limited to an optical network terminal (ONT) located on the customer premises 12, an optical network unit (ONU) located at the curb (i.e., on the street in the neighborhood of the customer premises 12), which unit connects several customer premises with the service provider network 10, and one or more network elements located at the service provider central office that function as an optical network unit. The diagnostic/management LAN 18 can connect to the service provider network 10 via a management interface device (MID) (not shown in FIG. 1, but shown in FIGS. 2-6).

It is within the scope of the FIG. 1 example embodiment to include other service providers (not shown) connected to the customer premises 12 and to include other customer premises connected to any given service provider. It is also within the scope of the FIG. 1 example embodiment to include elements of the service provider network 10 and the customer premises 12 that are not shown in FIG. 1. In one example embodiment CPE 14 represents a single piece of equipment, while in another example embodiment CPE 14 represents a plurality of pieces of equipment.

The CPE 14 can include, but are not limited to, any type of: broadband home router; computer; alarm system; digital camera; wired telephone including an analog POTS (plain old telephone service) telephone, telephone receiving service over a cable system, an IP (internet protocol) telephone including a session-initiation-protocol (SIP) telephone, and a voice-over-internet-protocol (VOIP) telephone, and a computer functioning as a telephone; wireless telephone including a portable telephone, a telephone using a WiFi, WiMAX or Bluetooth signal, a cellular telephone (using GSM, CDMA or TDMA protocols) and a telephone using a femtocell protocol; television; computer functioning as a television; electronic device and box connected to a television including but not limited to a set top box, a direct broadcast satellite device, a cable box, and any type of computer; cable modem; access point base station (femtocell); and user communication appliance the performs one or more of the functions of the previously-noted devices. As a result, 1) for CPE comprising a telephone, the primary services communication comprises telephone signals (using analog or digital protocols, wired or wireless protocols, or any type of internet protocols, depending on the type of telephone), 2) for CPE comprising a computer, the primary services communication comprises internet or intranet access or other internet or intranet signals, 3) for CPE comprising a television, the primary services communication comprises cable television signals, direct satellite broadcast signals, or broadcast television signals, 4) for CPE comprising a computer functioning as a television, the primary services communication comprises internet protocol television signals, 5) for CPE comprising a computer functioning as a telephone or to provide telephone services, the primary services communication comprises internet protocol telephone signals, and 6) for CPE comprising an alarm system, the primary services communication comprises signals following any alarm protocol.

FIG. 2 illustrates non-limiting examples of the devices that connect a service provider network 30 to a primary services LAN A, and to a diagnostic/management LAN B. The service provider network 30 can be the same as or different from the service provider network 10 shown in FIG. 1. In addition, the primary services LAN A, and the diagnostic/management LAN B shown in FIG. 2 can be the same as or different from the primary services LAN A, and the diagnostic/management LAN B shown in FIG. 1. The service provider network 30 can include a core network 32 and a management system 34. The core network 32 can transmit primary services signals to and receive primary services signals from the CPE (not shown) via a services interface device (SID) 36, while the management system 34 can transmit diagnostic and/or management signals to and receive management and/or diagnostic signals from the CPE (not shown) via a management interface device 38 (MID). In one example embodiment, the SID 36 is physically separated from the MID 38, while in another example embodiment the SID 36 and the MID 38 are integrated into one device. In addition, the SID 36 can be located on the customer's premises (in which case, in one non-limiting example embodiment the SID can be an ONT), at the curb (i.e., on the street in the neighborhood of the customer premises, in which case, in one non-limiting example embodiment, the SID can be an ONU), or at the service provider central office. Similarly, the MID 38 can be located on the customer's premises, at the curb, or at the service provider central office. The SID 36 and the MID 38 are located and constructed so as to permit access thereto by the service provider. As shown in FIG. 2, the MID 38 connects to the management system 34 along a separate communications path from the path the SID 36 communicates with the core network 32. But it is within the scope of this example embodiment for the MID 38 to communicate with the management system 34 through the SID 36 or for the SID 36 to communicate with the core network 32 through the MID 38.

The primary services LAN A and the diagnostic/management LAN B shown in FIGS. 1 and 2 can be either wired or wireless LANs. Non-limiting examples of such wired LANs include a LAN using a MoCA protocol, a LAN using a HPNA/HPNA3 protocol, a LAN comprising electrical power lines on the customers premises using any power line communication protocol, and an Ethernet LAN using any type of Ethernet cable. Non-limiting examples of such wireless LANs include a wireless WiFi network using the 802.11g protocol, a wireless WiFi network using the 802.11n protocol, a wireless network using the blue-tooth protocol, a wireless network using a femtocell protocol, a unidirectional RFID network (radio frequency identification), and a wireless WiMAX network. In addition, the primary services LAN A and the diagnostic/management LAN B shown in FIG. 1 can be the same as or different from the primary services LAN A and the diagnostic/management LAN B shown in FIG. 2.

The MID 38 can include a management and/or diagnostic mediation function to facilitate management and/or diagnostic communication with the CPE over the LAN B and with the management system 22 over the WAN of the service provider. In addition, the MID 38 can terminate one or more LAN interfaces between the CPE and the MID 38. Further, the MID 38 can provide management and/or diagnostic communications with the CPE remotely from the central office of the service provider or from a remote NMS/EMS OSS (network management system/element management system/operations support system). Also, the MID 38 can provide management and/or diagnostic communications with the CPE locally when the MID 38 is deployed on or near the customer premises. Management and/or diagnostic communications between the MID 38 and the CPE are performed by transmitting management and/or diagnostic signals between the CPE and the MID 38 and/or between the MID 38 and the management system 22. This management/diagnostic communication can be used to perform verification of autonomous notifications from the CPE, to perform troubleshooting of the LAN A and/or the LAN B, to perform diagnostics on the CPE, perform configuration operations on the CPE, to validate the identity and compatibility of the CPE, and/or to perform automatic switchover for services, such as switchover of voice services when the user is in the vicinity (with a cell phone or a wireless VoIP phone). These functions can minimize the number of times technicians are dispatched to the customer's premises for on-site fault isolation, to minimize customer downtime, and to improve customer satisfaction. It should be understood that the diagnostic and management functions of the MID are not limited to the functions noted above and can include other functions. In addition, in another example embodiment, the primary services signals can be transmitted between the MID 38 and the CPE and between the MID and the core network 32. In this example embodiment, the MID can be configured to transmit the primary services to and receive the primary services signals from the CPE and the core network 32.

Both the SID 36 and the MID 38 can include, but are not limited to a wireline devices, wireless devices, digital devices, analog devices, optical device, and electrical devices, such as DSL devices. More generally, the SID 36 and the MID 38 can be of a type to connect to any type of service provider wired network using any type of wired protocol and any type of wireless network using any type of wireless protocol. Therefore, the SID 36 and the MID 38 can be a devices configured to connect to a service provider wirelessly over a WiMAX network or through a wired connection over a GPON network, for example. In addition, the SID 36 and the MID 38 can include, but are not limited to, other wired network interfaces to connect to any other type of wired service provider network, such as a passive optical network (non-limiting examples of which include a BPON (Broadband Passive Optical Network), an WDM-PON (Wavelength Division Multiplexing Passive Optical Network), a GPON (Gigabyte Passive Optical Network)), a cable network, a copper wire analog telephone network, and a DSL network. The SID 36 and the MID 38 can also be a type of network interface device that connects to other wireless service provider networks, such as a direct broadcast satellite network, a WiFi network, and a cellular network (for example, a GSM network and a CDMA network). In addition, when the SID 36 and the MID 38 are wired network interface devices, they can be configured to connect to wired service provider networks following any wired network protocol, such as, but not limited to, the broadband passive optical network protocol according to the ITU G.983.x standard, the gigabit passive optical network protocol according to the ITU G.984.x standard, the Ethernet passive optical network protocol, the wavelength division multiplexing passive optical network protocol, the cable modem protocol comprising one of the DOCSIS 2.0 protocol and the DOCSIS 3.0 protocol, and the xDSL protocol comprising one of the ADSL ANSI T1.413 Issue 2 protocol, the ITU G.992.1 (G.DMT) protocol, the ITU G.992.2 (G.Lite) protocol, the ADSL2 ITU G.992.3/4 protocol, the ITU G.992.3 Annex J protocol, the ITU G.992.3 Annex L protocol, the ADSL2+ITU G.992.5 protocol, the ITU G.992.5 Annex L protocol, and the ITU G.992.5 Annex M protocol. As a result, the wireline signal transmitted from the service provider to the SID 36 and the MID 38 can be, but is not limited to, a wavelength division multiplexed optical signal, a dense wavelength division multiplexed optical signal, or an electrical signal comprising one of a cable modem signal, an analog telephone signal, and an xDSL signal. When the SID 36 and the MID 38 are wireless network interface devices, they can be configured to connect to wireless service provider networks following any wireless network protocol, such as, but not limited to, the WiMAX protocol according to the IEEE 802.16 standards, the WiFi protocol according to the 802.11 standards, the cellular phone protocol comprising the GSM protocol and the CDMA protocol, and the femtocell protocol. As a result, the wireless signal transmitted from the service provider can be, but is not limited to, a WiMAX signal, a WiFi signal, a cellular phone signal, a direct broadcast satellite signal, or a femtocell signal. It should be understood that the SID 36 and the MID 38 are not limited to devices that can be configured to connect to these service provider wired and wireless networks and protocols mentioned above, and can include network interface devices connectable to other types of wired and wireless networks using any other communications protocols. Also, the CPE (not shown) to be connected to the LAN A and LAN B in this example embodiment can be the same as or different from the CPE 14 shown FIG. 1.

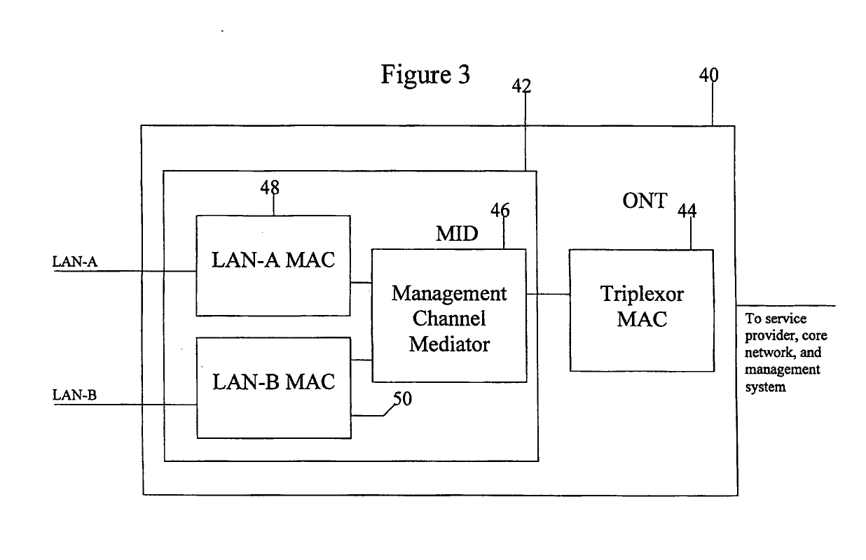

FIG. 3 shows one example embodiment in which the SID is in the form of an ONT 40 with a MID 42 integrated thereinto. The ONT 40 can include the MID 42 and a triplexor MAC (media access control) 44 connected thereto. The triplexor MAC 44 can be connected to the core network of the service provider and to the management system of the service provider. As a result, the MID 42 can connect to the management system through the triplexor MAC 44. The MID 42 can comprise a management channel mediator 46, a LAN-A MAC 48, connected to a primary services LAN A, and a LAN-B MAC 50, connected to a diagnostic/management LAN B. The MID 42 can be the same as the MID 38 shown in FIG. 2 or different therefrom. In addition, the primary services LAN A, and the diagnostic/management LAN B can be the same as or different from the primary services LAN A and the diagnostic/management LAN B shown in FIG. 1 and/or FIG. 2, respectively. The primary services LAN A, and the diagnostic/management LAN B can terminate at the MID 42. More specifically, the primary services LAN A can terminate at the LAN-A MAC 48, and the diagnostic/management LAN B can terminate at the LAN-B MAC 50. In addition, the ONT 40 and the MID 42 can include additional elements not shown in FIG. 3. Also, it is within the scope of the FIG. 3 example embodiment to replace the ONT 40 with another element or elements that performs or perform the same or a similar function. And it is within the scope of this example embodiment to replace each of the triplexor MAC 44, the LAN-A MAC 48 and the LAN-B MAC 50 with another element or elements that performs or perform the same or a similar function. The CPE (not shown) to be connected to the LAN A and LAN B in this example embodiment can be the same as or different from the CPE shown in or referred to in the description of FIGS. 1 and 2.

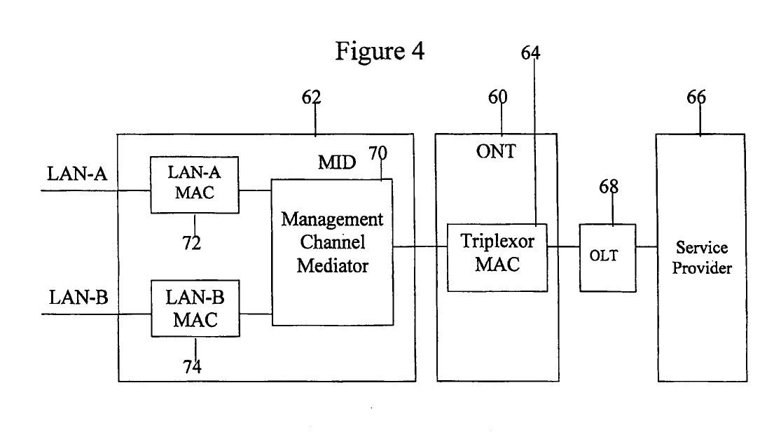

FIG. 4 shows one example embodiment in which the SID is in the form of an ONT 60 with a MID 62 separate therefrom. The ONT 60 can include a triplexor MAC 64 connected thereto. The triplexor MAC 64 can be connected to the core network of a service provider 66 and to the management system of the service provider 66 through an OLT (optical line termination unit) 68. As a result, the MID 62 can connect to the management system through the triplexor MAC 64. (In an alternative example embodiment, the MID 62 can connect directly to the management system of the service provider 66 by a different path than through the ONT 60.) The MID 62 can comprise a management channel mediator 70, a LAN-A MAC 72, connected to a primary services LAN A, and a LAN-B MAC 74, connected to a diagnostic/management LAN B. The MID 62 can be the same as the MID 38 shown in FIG. 2 or different therefrom and can be the same as the MID 42 shown in FIG. 3 or different therefrom. In addition, the primary services LAN A, and the diagnostic/management LAN B can be the same as or different from the primary services LAN A and the diagnostic/management LAN B, respectively, shown in FIGS. 1-3. The primary services LAN A, and the diagnostic/management LAN B can terminate at the MID 62. More specifically, the primary services LAN A can terminate at the LAN-A MAC 72, and the diagnostic/management LAN B can terminate at the LAN-B MAC 74. In addition, the ONT 60 can be the same as or different from the ONT 40 shown in FIG. 3. Also, the ONT 60 and the MID 62 can include additional elements not shown in FIG. 4. It is also within the scope of the FIG. 4 example embodiment to replace the ONT 60 with another element or elements that performs or perform the same or a similar function. And it is within the scope of the FIG. 4 example embodiment to replace each of the OLT 68, the triplexor MAC 64, the LAN-A MAC 72 and the LAN-B MAC 74 with another element or elements that performs or perform the same or a similar function. The CPE (not shown) to be connected to the LAN A and LAN B in this example embodiment can be the same as or different from the CPE shown in or referred to in the description of FIGS. 1-3.

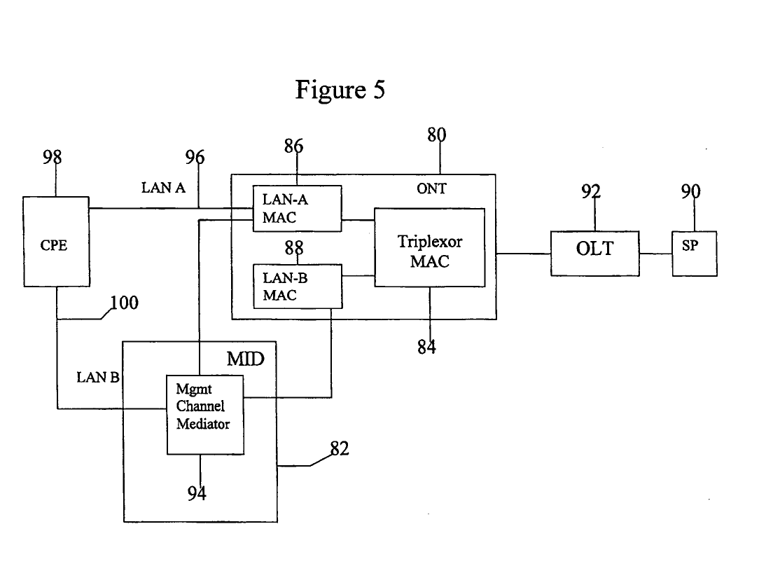

FIG. 5 shows another example embodiment in which the SID is in the form of an ONT (in this case ONT 80) with a MID (in this case MID 82) separate therefrom. But in this case, the two LANs terminate at the ONT 80. The ONT 80 can include a triplexor MAC 84, and a LAN-A MAC 86 and a LAN-B MAC 88 connected to the triplexor MAC 84. The triplexor MAC 84 can be connected to the core network and the management system of a service provider 90 through an OLT 92. As a result, the MID 82 can connect to the management system through the triplexor MAC 84. (In an alternative example embodiment, the MID 84 can connect directly to the management system of the service provider 90 by a different path than through the ONT 80.) The MID 82 can comprise a management channel mediator 94. A primary services LAN A 96 connects CPE 98 to the LAN-A MAC 86. A diagnostic/management LAN B 100 connects the CPE 98 to the management channel mediator 94 of the MID 82, and the management channel mediator 94 is connected to the LAN-B MAC 88 of the ONT 80. In addition, the LAN-A MAC 86 is also connected to the management channel mediator 94 of the MID 82. This connection permits the MID to perform or facilitate the performing of troubleshooting on and configuring of the primary services LAN A 96. The MID 82 can be the same as the MID 38 shown in FIG. 2 or different therefrom, can be the same as the MID 42 shown in FIG. 3 or different therefrom, and can be the same as or different from the MID 62 shown in FIG. 4. In addition, the primary services LAN A 96, and the diagnostic/management LAN B 100 can be the same as or different from the primary services LAN A and the diagnostic/management LAN B shown in FIGS. 1-4, respectively. The primary services LAN A 96, and the diagnostic/management LAN B 100 can terminate at the ONT 80. More specifically, the primary services LAN A 96 can terminate at the LAN-A MAC 86 of the ONT 80, and the diagnostic/management LAN B 100 can terminate at the LAN-B MAC 88 of the ONT 80. In addition, the ONT 80 can be the same as or different from the ONT 40 shown in FIG. 3, and can be the same as or different from the ONT 60 shown in FIG. 4. Also, the ONT 80 and the MID 82 can include additional elements not shown in FIG. 5. It is also within the scope of the FIG. 5 example embodiment to replace the ONT 80 with another element or elements that performs or perform the same or a similar function. And it is within the scope of this example embodiment to replace each of the OLT 92, the triplexor MAC 84, the LAN-A MAC 86, and the LAN-B MAC 88 with another element or elements that performs or perform the same or a similar function. Further, the CPE 98 can represent one piece of customer premises equipment or multiple pieces of customer premises equipment that can be the same as or different from the CPE shown in or referred to in the description of FIGS. 1-4.

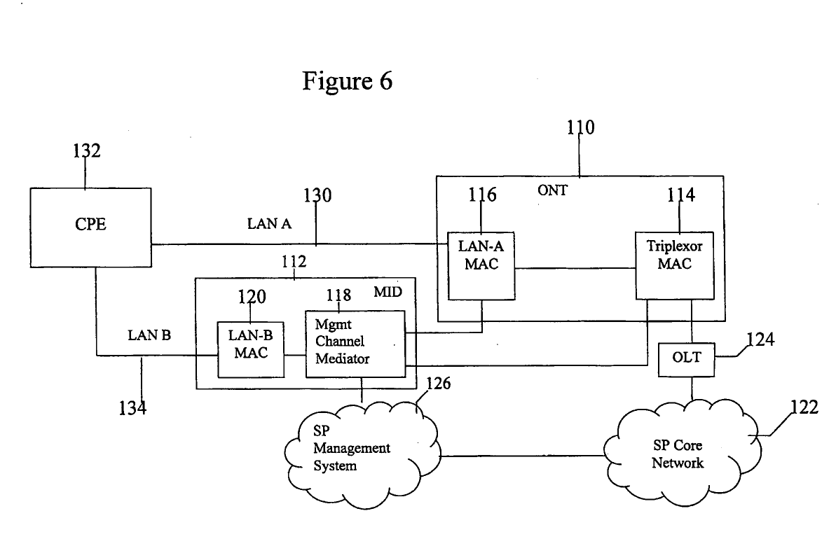

FIG. 6 shows another example embodiment in which the SID is in the form of an ONT (in this case ONT 110) with a MID (in this case, MID 112) separate therefrom. But in this case, one of the LANs terminates at the ONT 110, while the other LAN terminates at the MID 112. The ONT 110 can include a triplexor MAC 114 and a LAN-A MAC 116 connected thereto, while the MID 112 can include a management channel mediator 118 and a LAN-B MAC 120 connected thereto. The triplexor MAC 114 of the ONT 110 can be connected to the core network 122 of a service provider through an OLT 124, while the management channel mediator 118 of the MID 112 can be connected to the management system 126 of the service provider. The management system 126 can be connected to the core network 122, as shown in FIG. 6. (In an alternative example embodiment, the MID 112 can connect to the management system 126 through the triplexor MAC 114.) A primary services LAN A 130 connects CPE 132 to the LAN-A MAC 116. A diagnostic/management LAN B 134 connects the CPE 132 to the LAN-B MAC 120 of the MID 112, thereby connecting the CPE 132 to the management channel mediator 118 of the MID 112. The management channel mediator 118 is connected to the LAN-A MAC 116 of the ONT 110. This connection permits the MID 112 to perform or facilitate the performing of troubleshooting on and configuring of the primary services LAN A 130. In addition, the management channel mediator 118 is connected to the triplexor MAC 114 of the ONT 110. The MID 112 can be the same as the MID 38 shown in FIG. 2 or different therefrom, can be the same as the MID 42 shown in FIG. 3 or different therefrom, can be the same as or different from the MID 62 shown in FIG. 4, and can be the same as or different from the MID 82 shown in FIG. 5. In addition, the primary services LAN A 130, and the diagnostic/management LAN B 134 can be the same as or different from the primary services LAN A and the diagnostic/management LAN B, respectively, shown in FIGS. 1-5. The primary services LAN A 130 can terminate at the ONT 110, and the diagnostic/management LAN B 134 can terminate at the MID 112. More specifically, the primary services LAN A 130 can terminate at the LAN-A MAC 116 of the ONT 110, and the diagnostic/management LAN B 134 can terminate at the LAN-B MAC 120 of the MID 112. In addition, the ONT 110 can be the same as or different from the ONT 40 shown in FIG. 3, can be the same as or different from the ONT 60 shown in FIG. 4, and can be the same as or different from the ONT 80 shown in FIG. 5. Also, the ONT 110 and the MID 112 can include additional elements not shown in FIG. 6. It is also within the scope of the FIG. 6 example embodiment to replace the ONT 110 with another element or elements that performs or perform the same or a similar function. And it is within the scope of this example embodiment to replace each of the OLT 124, the triplexor MAC 114, the LAN-A MAC 116, and the LAN-B MAC 120 with another element or elements that performs or perform the same or a similar function. Further, the CPE 132 can represent one piece of customer premises equipment or multiple pieces of customer premises equipment that can be the same as or different from the CPE shown in or referred to in the description of FIGS. 1-5.

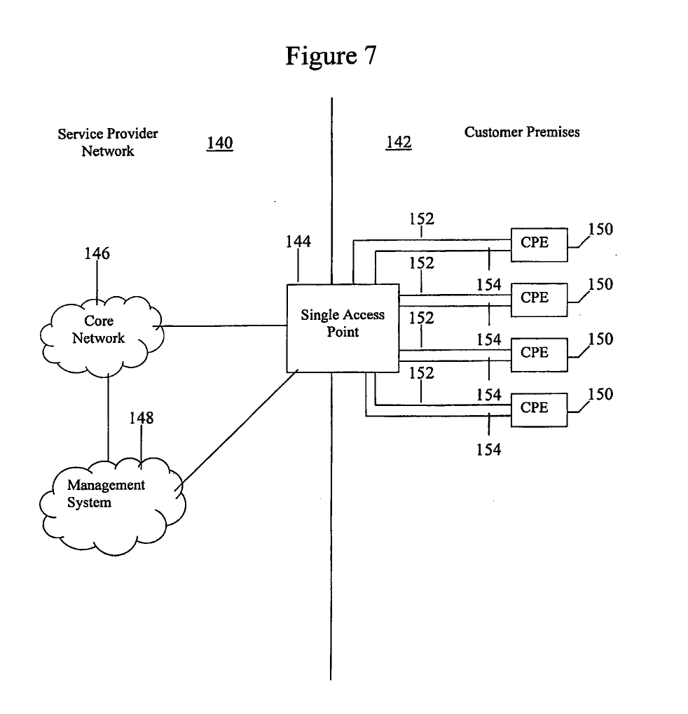

FIG. 7 shows an example embodiment of a service provider network 140 connected to customer premises 142 through a single access point 144. More specifically, the service provider network can comprise a core network 146 and a management system 148. The core network 146 can deliver or support the delivery of primary services and primary service signals to various pieces of CPE 150 over a primary services LAN A 152, while the management system 148 can deliver or support the delivery of management and/or diagnostic services and management and/or diagnostic signals to the various pieces of CPE 150 over a diagnostic/management LAN B 154. The single access point 144 can include any of the MIDs and the SIDs referred to in FIGS. 2-6 or can include an MID and an SID different from those referred to in FIGS. 2-6. In addition, each of the core network 146, the management system 148, the CPE 150, the primary services LAN A 152, and the diagnostic/management LAN B 154 can be the same as or different from the core network, the management system, the CPE, the primary services LAN A, and the diagnostic/management LAN B shown in or referred to in the description of FIGS. 1-6. Also, it is within the scope of the FIG. 7 example embodiment for each of the core network 146, the management system 148, the CPE 150, the primary services LAN A 152, and the diagnostic/management LAN B 154 to be replaced by an element or elements that performs or perform the same or a similar function. Moreover, it is also within the scope of the FIG. 7 example embodiment for the system shown therein to include additional elements not shown therein.

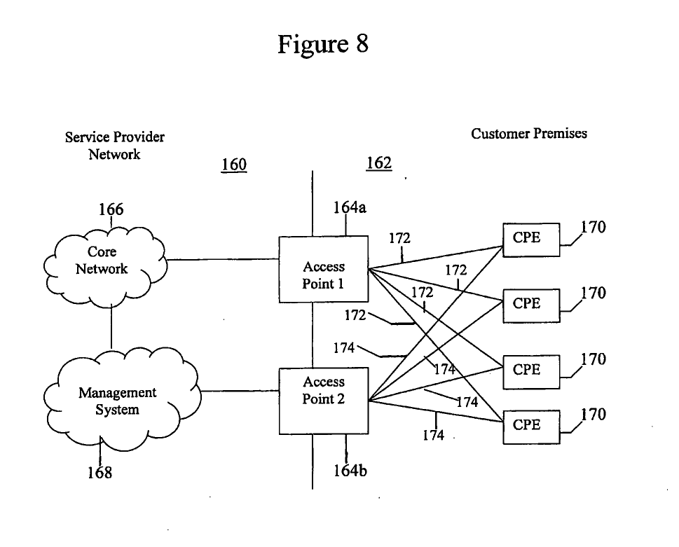

FIG. 8 shows an example embodiment of a service provider network 160 connected to customer premises 162 through two access points 164a and 164b. More specifically, the service provider network 160 can comprise a core network 166 and a management system 168. The core network 166 can deliver or support the delivery of primary services and primary service signals to various pieces of CPE 170 through the access point 164a and over a primary services LAN A 172, while the management system 168 can deliver or support the delivery of management and/or diagnostic services and management and/or diagnostic signals to the various pieces of CPE 170 through the access point 164b and over a diagnostic/management LAN B 174. The access point 164a can include any of the SIDs referred to in FIGS. 2-7 or can include a SID different from those referred to in the description of FIGS. 2-7. The access point 164b can include any of the MIDs referred to in FIGS. 2-7 or can include an MID different from those referred to in FIGS. 2-7. In addition, each of the core network 166, the management system 168, the CPE 170, the primary services LAN A 172, and the diagnostic/management LAN B 174 can be the same as or different from the core network, the management system, the CPE, the primary services LAN A, and the diagnostic/management LAN B shown in or referred to in the description of FIGS. 1-7. Also, it is within the scope of the FIG. 8 example embodiment for each of the core network 166, the management system 168, the CPE 170, the primary services LAN A 172, and the diagnostic/management LAN B 174 to be replaced by an element or elements that performs or perform the same or a similar function. Moreover, it is also within the scope of the FIG. 8 example embodiment for the system shown therein to include additional elements not shown therein.

The primary services LAN A and/or the diagnostic/management LAN B shown in FIGS. 1-8 can comprise wired connections to the CPE. More specifically, the wired connections can comprise a twisted pair of wires for providing analog phone service to telephones in the event the CPE are single-mode POTS telephones or dual mode telephones with an analog POTS function. The wired connections can also be wires permitting the communication of digital signals to telephones in the event that the CPE are single mode digital phones or dual mode phones with a digital function. The wired connections can also comprise wired connections designed to transmit data to and from personal computers, such as, but not limited to Ethernet cables and HPNA3 cables via a twisted pair of wires, etc., in the event one of the pieces of CPE is a computer. The wired connections can also comprise wired connections designed to transmit data to and from STBs or integrated TVs, such as, but not limited to a MoCA cable designed to transmit data using a MoCA protocol using an RF connector. The wired connections can further comprise USB cables connecting a broadband home router (BHR) with a digital camera. But these wired connections are not limited to the types of wires noted above and can be replaced by any other types of wired connections permitting the communication of signals to and from the CPE. For example, one or more of these wired connections can be replaced by power line communication (PLC) using the power-transmitting electrical wiring on the customer's premises to transmit signals to and from one or more pieces of CPE. In one example embodiment, the X-10 protocol for PLC can be used, though this example embodiment is not limited to using this protocol for transmitting signals over the customer's electrical wiring. Thus, the wired connections can support bidirectional communication with the CPE although they not limited thereto.

The primary services LAN A and/or the diagnostic/management LAN B shown in FIGS. 1-8 can comprise a wireless LAN, wirelessly connecting, for example, the SID and/or the MID with the CPE. Thus, the CPE, the SID, and the MID (or equipment that connect to the SID and the MID, such as a BHR), can include wireless WiFi transceivers to transmit WiFi signals to and receive WiFi from each other. But it is within the scope of the example embodiments shown in FIGS. 1-8 to use any other type of wireless signals, protocols, and transceivers to connect any of the CPE to the SID and the MID, such as WiMAX signals, protocols, and transceivers, Bluetooth signals, protocols, and transceivers, cellular signals, protocols, and transceivers, etc. In addition, one or more pieces of CPE can include an RF-ID transmitter that sends RF-ID signals therefrom to an RF-ID receiver of a BHR connected to the MID, which receives RF-ID signals, to permit identification of the CPE. The wireless connections can support bidirectional communication with the CPE, although they are not limited thereto. The RF-ID transmitter and the RF-ID receiver support unidirectional communication from the CPE to the BHR and the MID, although they are not limited thereto.

The RF-ID signals can provide end-point information to the MID to aid the service provider 1) in the initial configuration of the CPE, 2) in detecting that CPE are on the customer premises, and 3) in switching a cellular phone over to an in-home VoIP wireless or wireline network when the customer is carrying a cellular telephone when entering the vicinity of the home. Other benefits of using RF-ID signals on the management/diagnostic LAN B is that the CPE can be automatically configured and managed by the MID as long as these pieces of CPE are either certified by the service provider, are certified to be compatible with the MID, or the user (or service provider) has configured the MID to be compatible with the given device that identifies itself via the RF-ID interface of the MID. Non-limiting examples of information that can be provided via the RF-ID interface and the RF-ID signals include: a MAC Address of the CPE, a serial number of the CPE, a password for the CPE, device-type information (i.e., whether the CPE is a TV, a STB, a phone, a personal computer, a network interface device, a BHR, a hub, a bridge, a camera, an NAS, etc), the device ID, the supported interfaces (i.e., 802.11g/n, Ethernet, etc), etc. But it should be understood that it is within the scope of this example embodiment for other types of signals to be transmitted from the CPE to the MID and any BHR connected thereto.

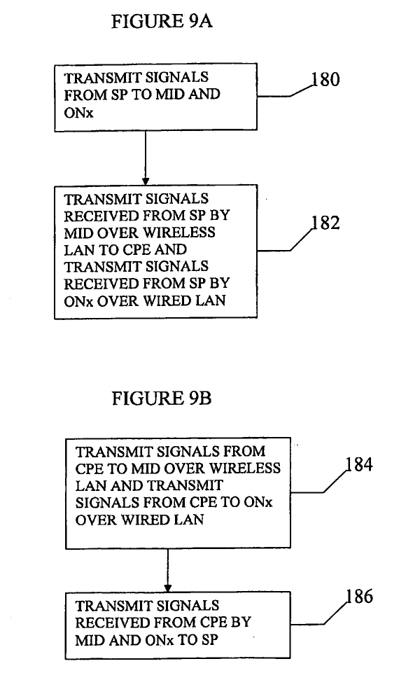

FIGS. 9A, 9B, 10A, 10B, 11A, 11B, and 12 are flow charts showing different example embodiments of performing communication between CPE and a service provider.

FIGS. 9A and 9B illustrate example embodiments of a procedure of bidirectionally communicating with CPE that receive a service or services from a service provider (SP) via both wired and wireless LANs. According to FIG. 9A, an operation (180) is performed in which the SP transmits signals to an MID and to either an ONT on the customer's premises, an ONU in the neighborhood of the customer's premises, or an element or elements of the network at the service provider's central office that perform the function of an ONU (these three possibilities being denoted as an ONx). Next, the MID transmits the signals received from the SP over a wireless management/diagnostic LAN B to the CPE, while the ONx transmits the signals received from the SP over a wired primary services LAN A (182). As shown in FIG. 9B, the CPE transmits signals to the MID over the wireless management/diagnostic LAN B and transmits signals to the ONx over the wired primary services LAN A (184). Next, the MID and the ONx transmit the signals received from the CPE to the SP (186). Each of the SP, the CPE, the MID, and the ONx can be the same as or different from the SP, the CPE, the MID, and the SID/ONx referred to in FIGS. 1-8, respectively.

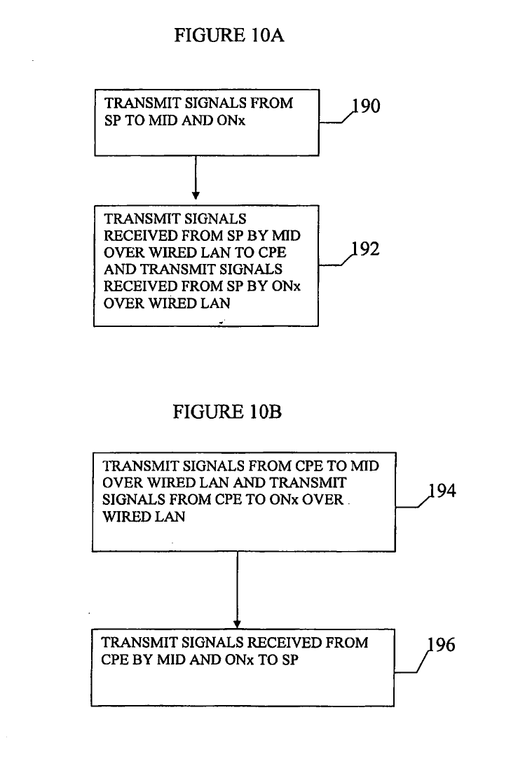

FIGS. 10A and 10B illustrate example embodiments of a procedure of bidirectionally communicating with CPE that receive a service or services from a SP via wired LANs. According to FIG. 10A, an operation (190) is performed in which the SP transmits signals to an MID and to an ONx. Next, the MID transmits the signals received from the SP over a wired management/diagnostic LAN B to the CPE, while the ONx transmits the signals received from the SP over a wired primary services LAN A (192). As shown in FIG. 10B, the CPE transmits signals to the MID over the wired management/diagnostic LAN B and transmits signals to the ONx over the wired primary services LAN A (194). Next, the MID and the ONx transmit the signals received from the CPE to the SP (196). Each of the SP, the CPE, the MID, and the ONx can be the same as or different from the SP, the CPE, the MID, and the SID/ONx referred to in FIGS. 1-8, FIG. 9A, and FIG. 9B respectively.

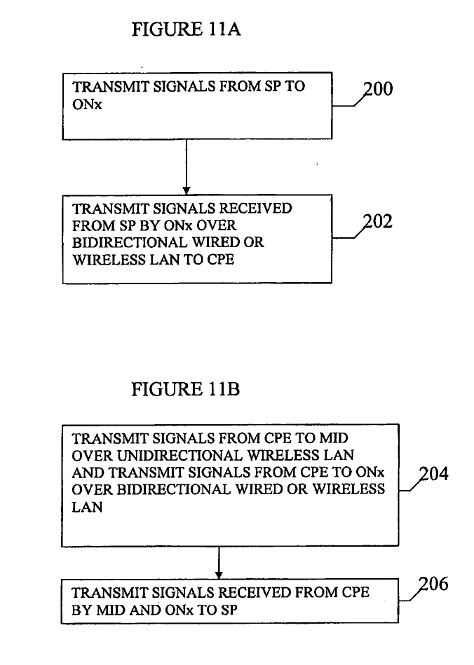

FIGS. 11A and 11B illustrate an example embodiment of a procedure of bidirectional primary services communication and unidirectional management/diagnostic communication with CPE. According to FIG. 11A, an operation (200) is performed in which the SP transmits signals to an ONx. Next, the ONx transmits the signals received from the SP over a wired or wireless primary services LAN A to CPE (202). As shown in FIG. 11B, the CPE transmits signals to the MID unidirectionally over a wireless management/diagnostic LAN B and transmits signals to the ONx over a bidirectional wired or wireless primary services LAN A (204). Next, the MID and the ONx transmit the signals received from the CPE to the SP (206). Each of the SP, the CPE, the MID, and the ONx can be the same as or different from the SP, the CPE, the MID, and the SID/ONx referred to in FIGS. 1-8, FIG. 9A, FIG. 9B, FIG. 10A, and FIG. 10B, respectively.

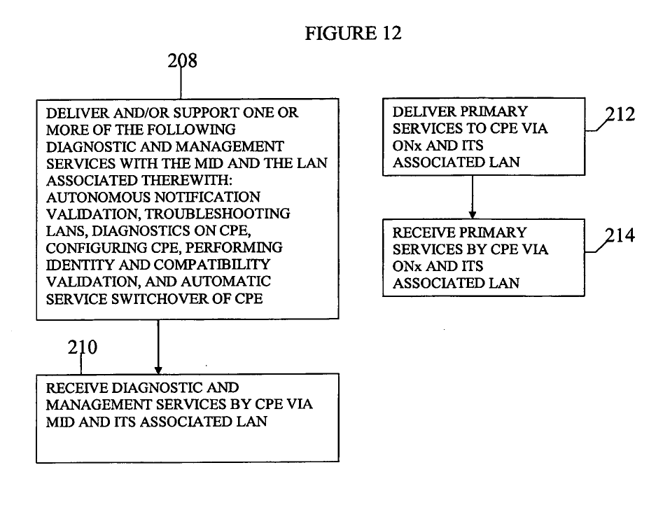

FIG. 12 illustrates an example embodiment of a procedure of delivering, receiving, and/or supporting different services by the MID, the CPE, and the LANs. In operation 208, the MID and its associated management/diagnostic LAN B deliver, receive, and/or support one or more of the following management and diagnostic services: performing verification of autonomous notifications from the CPE; performing troubleshooting of the primary services LAN A and the management/diagnostic LAN B; performing diagnostics on the CPE; configuring the CPE; validating of the identity and compatibility of the CPE; and performing automatic switchover of services for the CPE. As a result, the CPE receive and/or support these diagnostic and/or management services via the management/diagnostic LAN B and the MID (210). Before, during, and/or after operations 208 and 210, operations 212 and 214 are performed. In operation 212, the ONx and the primary services LAN A deliver primary services and primary services signals to the CPE, receive primary services and primary services signals from the CPE, and/or support primary services for the CPE. As a result, the CPE receive, support, and/or perform these primary services (214). Each of the CPE, the MID, the ONx, the primary services LAN A, and the management/diagnostic services LAN B can be the same as or different from the CPE, the MID, the SID/ONx, the primary services LAN A, and the management/diagnostic services LAN B, respectively, referred to in FIGS. 1-8, FIG. 9A, FIG. 9B, FIG. 10A, FIG. 10B, FIG. 11A, and FIG. 11B.

In another example embodiment, fault isolation can be performed by any of the equipment shown in FIGS. 1-8 in the event that any piece of CPE fails to deliver and/or support primary services to the customer. Such a procedure has the potential to avoid a costly service call from the SP to the customer, as will be discussed below. And such a procedure is made possible by the use of the MID and the management/diagnostic services LAN B. This can be seen as follows. In the absence of the management/diagnostic services LAN B and the MID, when a piece of CPE fails to deliver and/or support primary services, the customer will call or email the SP to report the interruption in service. As a result, the SP verifies the functioning of equipment from the central office of the SP network up to the CPE that has failed. Next, the SP may be able to diagnose and troubleshoot the CPE if a) the CPE is operational (i.e., has power and is functioning correctly, and b) the primary services LAN-A is operational (wired and installed correctly if wired, or provisioned and functioning correctly if wireless). However, if either a) or b) are not true, then the SP cannot communicate with the CPE. As a result, a technician must be dispatched by the SPE to the CPE to troubleshoot the root cause of the failure to deliver primary services to the customer and to fix the problem once its cause is known. The use of the MID and the management/diagnostic services LAN B offers a mechanism to diagnose and possibly solve the problem even if conditions a) and/or b) are present. (It is possible that both LAN-A and LAN-B will be down or malfunctioning simultaneously, making it impossible to use the LAN-B to perform fault isolation, but this possibility is highly unlikely, except when there is a power outage at the customer's premises. And if the problem is a power outage, the problem will be solved when the power returns. Moreover, there are ways the SP can determine whether the CPE failure is due to a power outage, for example, by the SP attempting to communicate to other CPE on the customer's premises, or by examining carrier equipment for telemetry indications of a power outage, such as by examining reports from ONTs that report utility power failure alarms.)

If the SP determines via diagnostic tests from the central office of the management system of the SP network that communication with the CPE occurs only over one of the LANs, then the SP can conclude that problem lies in one of the LANs. As a result, the SP can send an email to the customer or telephone the customer to ask the customer to correct the problem, since the customer owns and maintains the LANs or to offer to dispatch a service technician at some cost to the customer. Thus, in the event a piece of CPE fails to deliver and/or support primary services due to the malfunctioning of primary services LAN-A, the SP can use the MID and the LAN-B to perform fault isolation and determine that the primary LAN-A is malfunctioning, and as a result, send a message to the customer informing the customer that LAN-A is malfunctioning and/or offering to dispatch a service technician to fix LAN-A. On the other hand, if the SP determines via diagnostic tests conducted from the management system of the SP network that both the LAN-A and the LAN-B are functioning properly and that a piece of CPE is malfunctioning, the SP can perform remote troubleshooting and diagnostic tests on the malfunctioning piece of CPE using the MID and the management/diagnostic services LAN-B. For example, the SP can use the MID to reset the malfunctioning piece of CPE, which may fix the problem, thereby avoiding a service call from a service technician. Moreover, it is within the scope of this example embodiment to automate this process so that in response to receiving a customer complaint of an interruption in service involving a piece of CPE, the management system of the SP can automatically instruct the MID to reset the piece of CPE that is subject of a customer complaint. Further, the MID could also be programmed to reset any of the pieces of CPE without the receipt of a customer complaint about a piece of CPE under certain logic scenarios. Of course, if the SP determines that communication has failed on both LAN A and LAN B for some reason other than a power outage, then the SP can dispatch a service technician to the customer premises for troubleshooting and corrective action.

The functions performed by the SIDs, the ONxs, the MIDs, the primary services LAN A, the management/diagnostic services LAN B, and the CPE shown in FIGS. 1-12 and the procedures illustrated in FIGS. 9A, 9B, 10A, 10B, 11A, 11B, and 12 may be provided as a software example embodiment comprising a software computer program or a computer program product, that may include but is not limited to an article of manufacture on a machine accessible or machine readable medium having instructions. The instructions on the machine accessible or machine-readable medium may be used to program a computer system or other electronic device. The machine-readable medium may include, but is not limited to, floppy diskettes, optical disks, CD-ROMs, and magneto-optical disks or other type of media/machine-readable medium suitable for storing or transmitting electronic instructions. The techniques described herein are not limited to any particular software configuration. They may find applicability in any computing or processing environment. The terms “machine accessible medium” or “machine readable medium” used herein shall include any medium that is capable of storing, encoding, or transmitting a sequence of instructions for execution by the machine and that cause the machine to perform any one of the procedures described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

While various example embodiments have been illustrated and described, it should be understood that the example embodiments have been presented by way of example, and not limitation. It will be apparent to persons skilled in the relevant art(s) that various changes in form and detail can be made therein in a computer program product or software, hardware or any combination thereof, without departing from the broader spirit and scope of the apparatus, system, and procedure disclosed herein. Thus, the apparatus, system, and procedures disclosed herein should not be limited by any above-described examples of embodiments, but should be defined only in accordance with the following claims and their equivalents.

In addition, it should be understood that the figures, which highlight the functionality and advantages of the example embodiments, are presented for example purposes only. The architecture of the example embodiments is sufficiently flexible and configurable, such that it may be utilized (and navigated) in ways other than that shown in the accompanying figures.

Furthermore, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the claims of this application in any way. It is also to be understood that the procedures recited in the claims need not be performed in the order presented.

What is claimed is:

1. A system for connecting customer premises equipment with a service provider network comprising:
a first local area network connecting the customer premises equipment to the service provider network and configured to transmit primary service signals to and receive primary service signals from the customer premises equipment; and
a second local area network connecting the customer premises equipment to the service provider network and configured to transmit diagnostic and/or management signals to the customer premises equipment and/or to receive diagnostic and/or management signals from the customer premises equipment.

2. The system recited by claim 1, the first and second local area networks comprising wireless local area networks.

3. The system recited by claim 1, the first and second local area networks comprising wired local area networks.

4. The system recited by claim 1, the diagnostic and/or management signals transmitted and/or received by the second local area network permitting the service provider to provide at least one of the following management and/or diagnostic services to the customer premises equipment: verification of autonomous notifications from the customer premises equipment; troubleshooting of the first and/or second local area network; performing diagnostics on the customer premises equipment; performing configuration operations on the customer premises equipment; validating the identity and compatibility of the customer premises equipment; and performing automatic switchover of services for the customer premises equipment.

5. The system recited by claim 1, the first local area network being one of a wireline and a wireless local area network and the second local area network being the other of a wireline and a wireless local area network.

6. The system recited by claim 1,
the first local area network being configured to deliver and/or support wireline or wireless telephone service in the event the customer premises equipment is a wireline or wireless telephone, respectively,
the first local area network being configured to deliver and/or support internet access or internet services in the event the customer premises equipment is a computer,
the first local area network being configured to deliver and/or support cable television service, direct satellite broadcast service or broadcast television service in the event the customer premises equipment is a television,
the first local area network being configured to deliver and/or support internet protocol television service in the event the customer premises equipment is a computer functioning as a television,
the first local area network being configured to deliver and/or support alarm services in the event that the customer premises equipment is an alarm system, and
the first local area network being configured to deliver and/or support telephone service in the event the customer premises equipment is a computer performing a telephone function.

7. The system recited by claim 1, the first local area network providing a bidirectional wireline or wireless connection to the customer premises equipment, and the second local area network providing a unidirectional wireless connection to the customer premises equipment.

8. The system recited by claim 1, the first local area network and/or the second local area network comprising a femtocell.

9. The system recited by claim 1, the first local area network and/or the second local area network comprising the power-supplying electrical wiring on the premises of the customer.

10. An apparatus for facilitating diagnostic and/or management communication via a diagnostic and/or management channel to customer premises equipment that provides, receives, and/or supports services from a service provider via a primary service channel, comprising:
a management interface device configured to connect to a network of the service provider and configured to transmit diagnostic and/or management signals to and receive diagnostic and/or management signals from the customer premises equipment via the diagnostic and/or management channel.

11. The apparatus recited by claim 10, the management interface device being part of an optical network unit or an optical network terminal.

12. The apparatus recited by claim 10, the management interface device being separate from an optical network unit or optical network terminal and being connected to a network of the service provider via a separate path from the optical network terminal and optical network unit.

13. The apparatus recited by claim 10, the management interface device being connected to the service provider network via an optical network terminal separate from the management interface device.

14. The apparatus recited by claim 13, the diagnostic and/or management channel and the primary service channel terminating at the management interface device.

15. The apparatus recited by claim 13, the diagnostic and/or management channel and the primary service channel terminating at the optical network terminal.

16. The apparatus recited by claim 13, the diagnostic and/or management channel terminating at the management interface device and the primary service channel terminating at the optical network terminal.

17. The apparatus recited by claim 10, the management interface device being connected to the customer premises equipment via the same access point as an optical network device through which primary services signal are routed to the customer premises equipment.

18. The apparatus recited by claim 10, the management interface device being connected to the customer premises equipment via a different access point than an optical network device through which primary services signal are routed to the customer premises equipment.

19. The apparatus recited by claim 10, the management interface device being located at one of the exterior of the customer's premises, a service-provider-controlled location, the service provider central office, and in a neighborhood of the customer premises to serve multiple customer premises in the neighborhood.

20. A procedure of communicating with customer premises equipment comprising:
performing management and/or diagnostic communication between a management interface device and the customer premises equipment over a first local area network, the management interface device being configured to also communicate with a management system of a service provider to permit management and/or diagnostic communication between the management system of the service provider and the customer premises equipment; and
performing primary-services communication between the customer premises equipment and a services interface device over a second local area network to provide or support primary services from the service provider, the services interface device being configured to connect to a core network of the service provider.

21. The procedure recited by claim 20,
the performing of communication over the first local area network comprising performing wireless communication over the first local area network when the first local area network is a wireless local area network, and
the performing of communication over the second local area network comprising performing wireline communication over the second local area network when the second local area network is a wireline local area network.

22. The procedure recited by claim 20,
the performing of communication over the first local area network comprising performing wireline communication over the first local area network when the first local area network is a wireline local area network, and
the performing of communication over the second local area network comprising performing wireline communication over the second local area network when the second local area network is a wireline local area network.

23. The procedure recited by claim 20,
the performing of communication over the first local area network comprising performing unidirectional wireless communication over the first local area network from the customer premises equipment to the management interface device when the first local area network is a unidirectional wireless local area network, and
the performing of communication over the second local area network comprising performing bidirectional wireline or wireless unidirectional wireless communication over the second local area network when the second local area network is a bidirectional wireline or wireless local area network, respectively.

24. The procedure recited by claim 20,
the performing of communication over the second local area network comprising delivering a primary service to the customer premises equipment, and
the performing of communication over the first local area network comprising delivering at least one of the following services: performing verification of autonomous notifications from the electronic device; performing troubleshooting of the first and/or second local area network; performing diagnostics on the customer premises equipment; performing configuration operations on the customer premises equipment; validating of the identity and compatibility of the customer premises equipment; and/or performing automatic switchover of services for the customer premises equipment.

25. The procedure recited by claim 20, further comprising:
the performing of fault isolation to determine the cause of the lack of delivery or support of primary-communications services by the customer premises equipment, when the customer premises equipment does not properly perform the primary-services communication; and
the performing of fault isolation using the properly functioning local area network when one of the local area networks is malfunctioning and the other local area network is properly functioning.

26. The procedure recited by claim 25,
in the event the performing of fault isolation determines that the cause of the lack of delivery or support of primary-communications services is the malfunctioning of the second local area network, the service provider sends a message to a user of the customer premises equipment to correct the malfunctioning or to offer to dispatch service personnel to correct the malfunctioning, and
in the event the performing of fault isolation determines that the cause of the lack of delivery or support of primary-communications services is the malfunctioning of the customer premises equipment, the service provider performs remote troubleshooting on the customer premises equipment for the purpose of restoring the delivery of primary-communications services to the user through the customer premises equipment.
